(19) United States
(12) Patent Application Publication
(10) Pub. No.: US 2009/0271369 A1
(43) Pub. Date: Oct. 29, 2009

(54) COMPUTER METHOD AND SYSTEM OF VISUAL REPRESENTATION OF EXTERNAL SOURCE DATA IN A VIRTUAL ENVIRONMENT

(75) Inventors: Li-Te Cheng, Malden, MA (US); Steven L. Rohall, Winchester, MA (US); John F. Patterson, Carlisle, MA (US); Masato Ikura, Holmdel, NJ (US); Phuong B. Le, Bloomington, IL (US)

Correspondence Address: HAMILTON, BROOK, SMITH & REYNOLDS, 530 VIRGINIA ROAD, PO BOX 9133, CONCORD, MA, 01742-9133, US

(73) Assignee: INTERNATIONAL BUSINESS MACHINES CORPORATION, Armonk, NY (US)

(21) Appl. No.: 12/110,584

(22) Filed: Apr. 28, 2008

(51) Int. Cl. G06F 17/30

(52) U.S. Cl. 707/3; 707/E17.014

(57) ABSTRACT

An external source data provider provides separable lists of external data in a virtual environment. The external source data provider and method particularly represent a query for external data in the virtual environment. The query is executed against external sources resulting in a plurality of items collectively forming search results. An output module displays the search results as a stream of discrete objects emanating from the representation of the search query in the virtual environment. Each object corresponds to or otherwise represents a respective search result item and operates as an individual data element Any user may persist, manipulate, share, annotate and modify one or more of the objects corresponding to the external data (i.e., respective search result item). Displayed objects that are left untouched by users disappear from display after a predefined period of time.

### BACKGROUND

Virtual worlds such as Second Life, There.com, IMVU, etc. are bringing in data from external sources, such as the web, and representing them in the virtual environment. For example, events in the Second Life features streaming video, blogs, web pages, etc. from outside Second Life. Users then benefit from viewing external data without leaving the comforts of their virtual environment.

One approach to visually representing external data is by projection. Typically the depiction of data from these external sources are literal projections of data on windows in the environment. For example, in Second Life, a streaming video or web page would appear as a dynamically updated texture rendered on a rectangular graphical surface. Or in Sun Microsystem's MPK20 environment, a fully interactive X-Windows-like window is projected onto a rectangular region on a virtual wall. The benefit of this approach is a literal/familiar representation—there is no interpretation required by the user. The drawback is lack of scalability for certain types of data. For instance, a long list of results requires some kind of user interface (e.g. scrollbar) or automatic transitions (e.g. autoscrolling). Also, individual pieces of data of interest are trapped inside the projection without resorting to additional user interface capabilities (e.g. mouse-selection/copy-paste).

Another approach is visualization. The stream of external data is mapped into a set of visual virtual objects arranged in some kind of meaningful layout. For example, scientific visualizations of airflow in NASA's virtual wind tunnel, or GIS map data from satellite imagery overlaid in map applications like Google Earth, would display virtual objects corresponding to physical/geographical phenomena in a virtual environment. The benefit of this approach is better scalability and understandability for certain large datasets (as opposed to displaying everything in a table of numbers in a projection). However, these visualizations are intended to be read-only: a specific mapping algorithm determines the layout of objects for a meaningful visualization—users can query for more information, but cannot readily change the layout randomly.

### SUMMARY

Applicants propose a novel technique that overcomes the limits of projection and visualization techniques for representing lists of results from external data sources in a virtual environment. Embodiments of the present invention involve four elements:

1) a virtual representation of a query for external data—which could be depicted by a projection, a visualization, or a simple virtual object with some text or graphics on it summarizing the query;

2) a stream of virtual objects emanating from the virtual representation of the query;

3) each object emanating from the virtual representation of the query represents an item in the list of external results. The object could be a projection, text, graphics, or abstract representation of the data; and

4) any user can take any object from the displayed stream—which user-selected object can then be persisted, manipulated, shared, annotated, modified, etc. with other users. Otherwise, untouched objects in the displayed stream eventually disappear from view.

In one embodiment, a computer-implemented method provides external source data in a virtual environment by:
representing (preparing and otherwise providing) a search query of a certain type in the virtual environment, the certain type of search query being for external data;
applying the search query to a data source external to the virtual environment, resulting in a plurality of items collectively forming search results; and
displaying the search results as a stream of discrete objects emanating from the search query representation in the virtual environment, each object representing a respective search result item of the plurality of items.

The representation of the external source data in the virtual environment may include a depiction of the query by any of a projection, a visualization and a virtual object.

The virtual environment display of the search results as a stream of separable, discrete objects includes emanating the stream in an upwards or outwards direction relative to the search query representation in the virtual environment.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a screen illustration during user query formulation in one embodiment of the present invention.

FIG. 2 is a schematic view of a screen view having a virtual world representation of the user specified search query in the embodiment of FIG. 1.

FIG. 3 is a schematic view of the virtual world screen view display of external source data search results in the embodiment of FIG. 1.

FIG. 4 is a schematic view of the graphical user interface for operating on or otherwise manipulating a user selected search result data item of FIG. 3.

FIG. 5 is a flow diagram of one embodiment of the present invention.

FIG. 6 is a schematic view of a computer network in which embodiments of the present invention are implemented.

FIG. 7 is a block diagram of computer nodes in the network of FIG. 6.

### DETAILED DESCRIPTION

The main advantages of the present invention are as follows:

1) Unlike a projection approach, the individual data elements from external sources are discrete, separate pieces, no longer trapped in a projection, and only require a simple natural gesture to extract (picking up/taking or otherwise selecting).

2) Unlike a visualization approach, this is not a read-only representation—users can take, share, persist, annotate, and/or modify the virtual objects in the stream.

3) Similar to a visualization, the stream of objects becomes a clear “beacon” of information to attract the attention of others in the virtual environment.

4) There are clear depictions of the query itself and the results, respectively, in the virtual environment—which provides a visual affordance for users to change the query object to change the results presented in the environment.

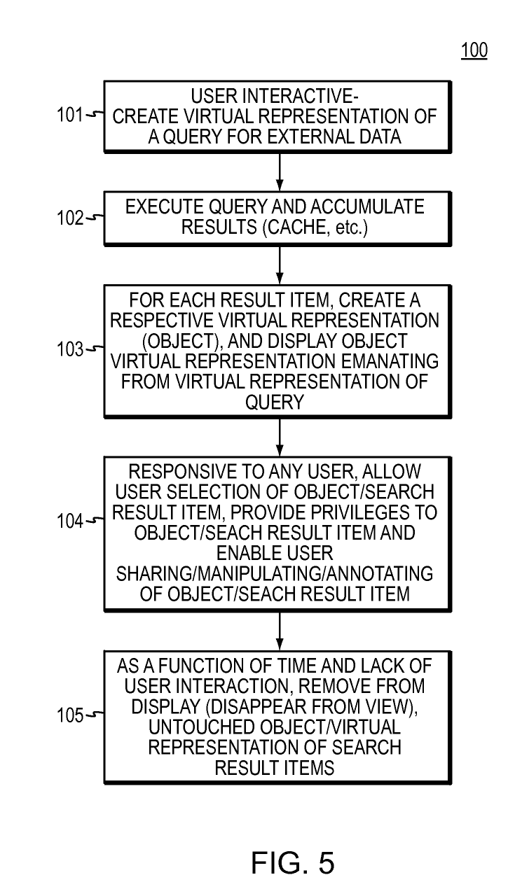

With reference to the flow diagram of FIG. 5, embodiments (such as external source data provider 100) of the present invention operate as follows. The steps modules or assemblies to implement embodiments of the present invention 100 are effectively user interface operations or parts of a user interface.

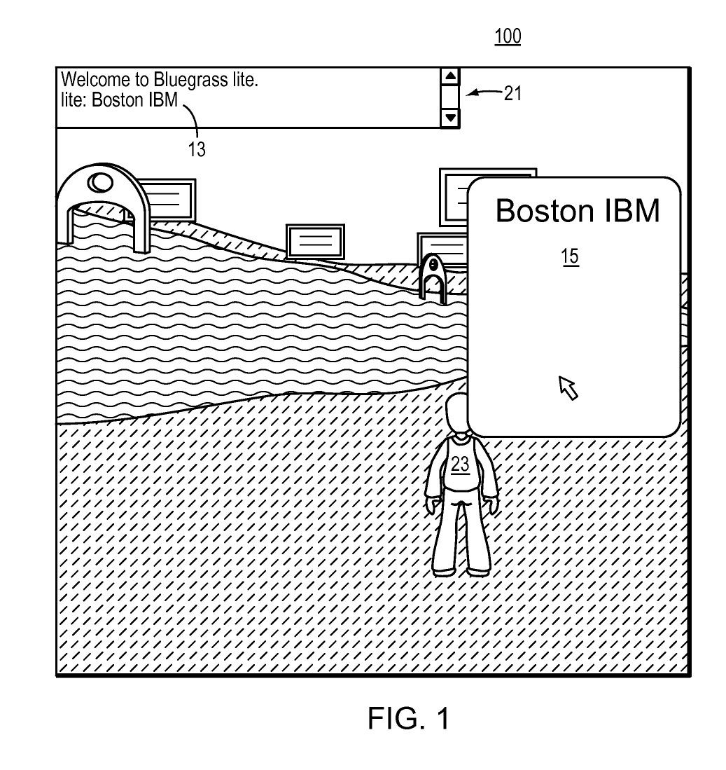

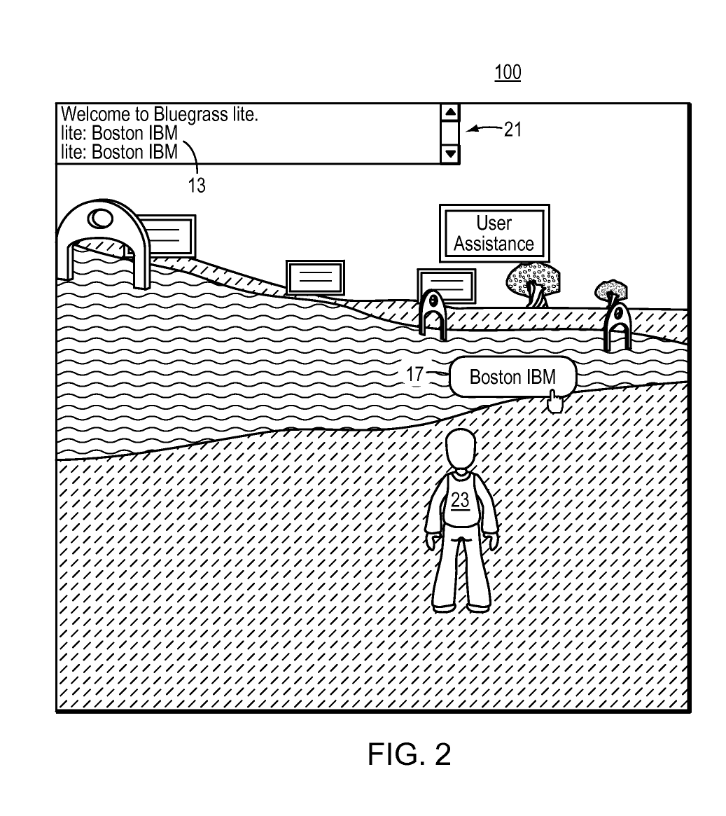

At step or interface member 101, the user creates a virtual representation of a query for external data. This may be accomplished by traditional user interfaces such as dialog boxes 21 (FIG. 1), context-menus, etc. Or a command-line style operation may be employed—for example, take some typed text in a persisted chat and transform it into a virtual representation of a query. The query may take the form of a database query, an RSS feed subscription, a Google-style text query, etc. The virtual representation takes the form of a simple object (such as at 17 in FIG. 2) in the virtual environment, a projection, or a visualization.

At step 102, the query for external data is executed at some point in time, or at some defined time interval (user-defined or predefined). Step 102 then accumulates the search results. The search results comprise one or more items (data elements) from a source external to the virtual environment.

This is accomplished by traditional API calls to an external service that provides the data results. For example, this may be done by interacting with a search engine API, a database system, an RSS feed, etc. A cache or other working memory for holding and accumulating received search results is utilized. In some embodiments, step 102 is accomplished by a search member or module.

At step 103, for each search result item, a respective virtual representation is created and emanated from the virtual representation of the query. This is accomplished by representing each search result item as a simple virtual object, a projection, etc., and then using the physics engine supporting the virtual environment to float the object upwards (outwards, etc.), for instance. Known or common physics engines may be configured to operate this way.

In some embodiments, step 103 is a output module or display module or the like.

Continuing to step or interface module 104, if the user selects/takes a virtual representation of a result item, then allow the user to take it, and provide privileges for the user to share it, manipulate it, annotate it, etc. This is accomplished by modifying the access permissions of the corresponding virtual object, and providing it properties as allowed by the virtual environment's engine to perform sharing, manipulating, annotating, etc.

In step 105, the invention system 100 removes from display unselected objects after a predetermined time threshold. Effectively, unselected objects at some moment in time disappear from view in the virtual environment. This is accomplished by using a timer thread to automatically dispose unused objects.

FIGS. 1-4 illustrate one example of an implementation (embodiment) of the invention system that provides data from a source external to a subject virtual environment. General support of the virtual environment and representation of the user through a respective avatar 23 is by common, known means, engines and techniques.

In FIG. 1, a user types in a dialogue box or work area 21 of the graphical user interface, a search query (“Boston IBM”) 13 which appears as a chat bubble 15. Then in FIG. 2 the user right clicks on the formed chat bubble 15 to turn it into a virtual representation 17 of a query. The query representation 17 may be particular to external source data queries and servers to be indicative of such.

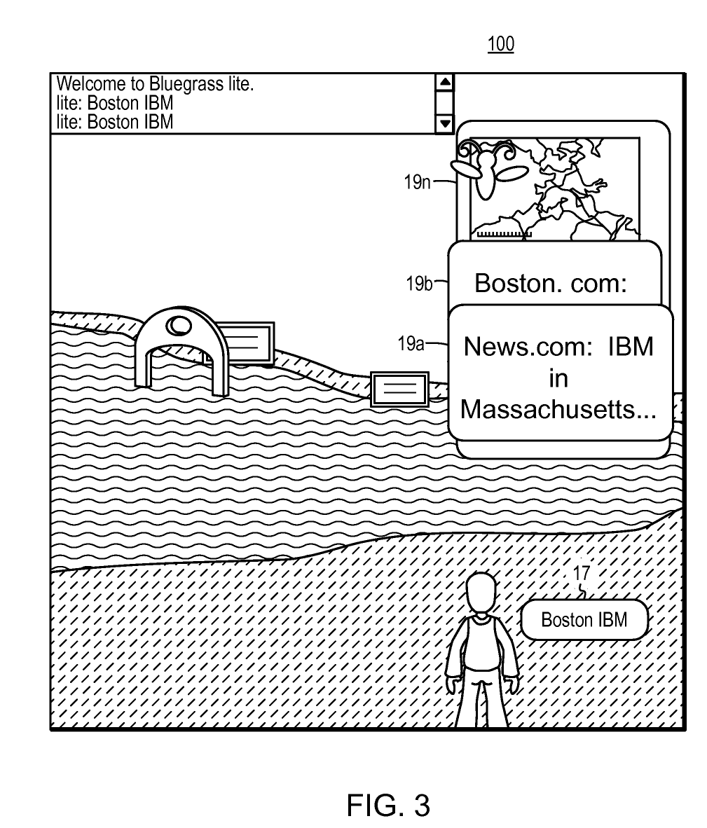

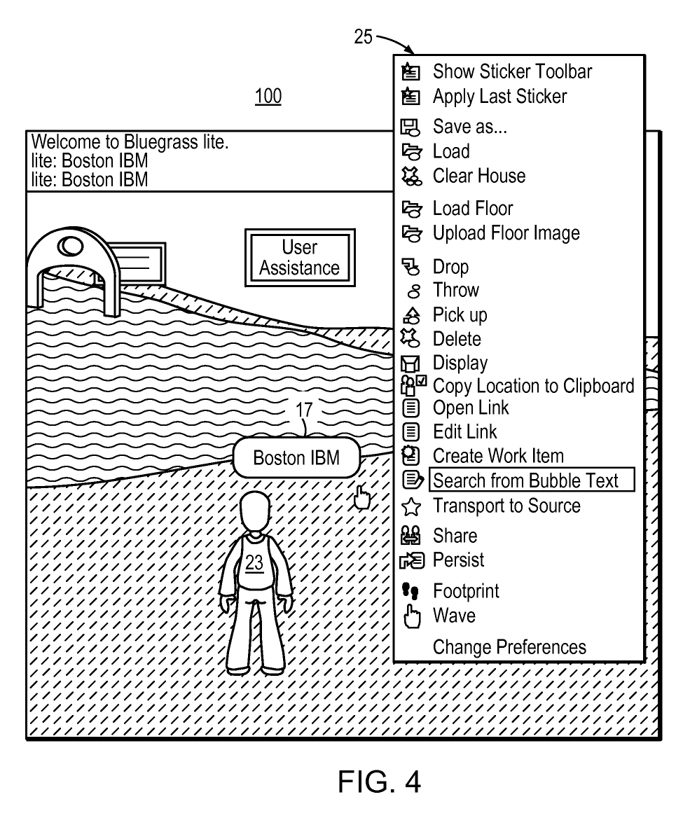

In turn, the invention system 100 (step 102) launches the requested search or otherwise has the user entered query 13 executed, and displays (step 103) the search results 19a, 19b . . . 19n in the form of individual (discrete) data elements. In embodiments of the invention, step 102 accumulates search result items forming the results. And step 103 renders (displays) a steam (list) of search result items 19a, 19b . . . n appearing as respective bubbles, screenshots, objects, etc., emanating from the search query object 17 as shown in FIG. 3. The user, and other users, can take any one of these objects (search result items) 19 for personal use, sharing, manipulation, annotations, etc. acting through his avatar 23 using known virtual world operations and techniques. For example, FIG. 4 illustrates the use of a drop down menu and menu selection 25 (graphical user interface) enabling the user to operate on or otherwise manipulate one or more of the displayed search result items 19. The operations include share, persist, copy, save as, pick up, drop, footprint and others known in the art. Other operations are suitable.

After a predetermined period of time has passed, untouched objects (search result items not user-interacted with) are removed from display and effectively disappear from view in the subject virtual world.

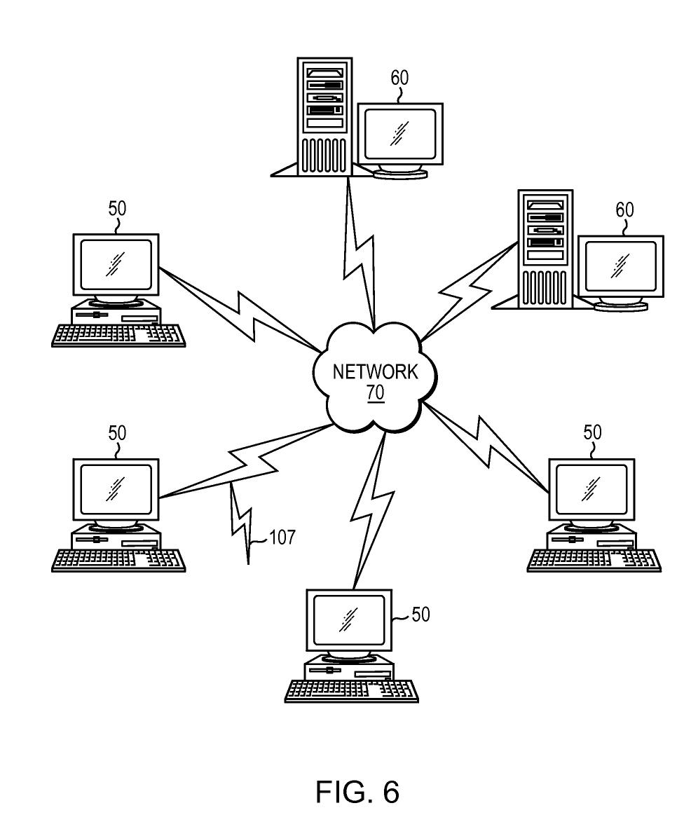

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

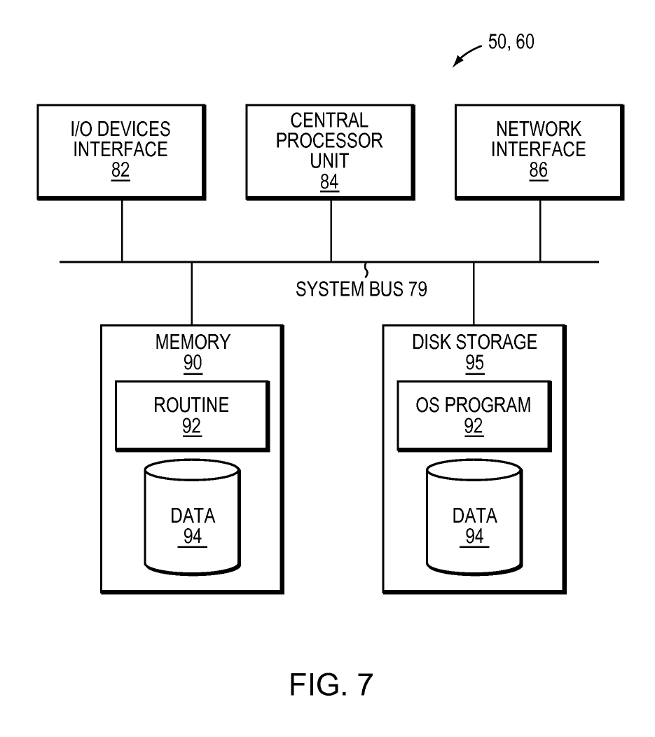

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention (e.g., external source data provider 100 and user interface code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While this invention has been particularly shown and described with references to example embodiments thereof, it will be understood by those skilled in the art that various changes in form and details may be made therein without departing from the scope of the invention encompassed by the appended claims.

For example, the above described virtual environment may be a 3D or other video game, a simulation, a multi-user online virtual world or other virtual world.

What is claimed is:

1. A computer-implemented method of providing external source data in a virtual environment comprising:
representing a search query of a certain type in the virtual environment, the certain type of search query being for external data;
applying the search query to a data source external to the virtual environment, resulting in a plurality of items collectively forming search results; and
displaying the search results as a stream of discrete objects emanating from representation of the search query in the virtual environment, each object representing a respective search result item of the plurality of items.

2. A computer-implemented method as claimed in claim 1 wherein representing a search query of a certain type includes depicting the query by any of a projection, a visualization and a virtual object.

3. A computer-implemented method as claimed in claim 1 wherein the displaying the search results as a stream of discrete objects includes emanating the stream in an upwards or outwards direction relative to the search query representation in the virtual environment.

4. A computer-implemented method as claimed in claim 1 wherein each object representing a respective search result item employs any of a projection, text, graphics and abstract representation of data.

5. A computer-implemented method as claimed in claim 1 further comprising enabling a user to take an object from the stream.

6. A computer-implemented method as claimed in claim 5 further enabling a user to operate on the taken object by any of persisting, manipulating, sharing, annotating and modifying the object.

7. A computer-implemented method as claimed in claim 1 wherein displaying the search results as a stream of discrete objects further includes making an object disappear from display after a predefined period of time.

8. A computer implemented method of claim 1 wherein the virtual environment is any of:
a virtual world, a 3D video, a simulation, a multi-user online environment and a virtual gaming environment.

9. An external source data provider comprising:
a user interface enabling users to represent a search query of a certain type in a virtual environment, the certain type of search query being for external data;
a search member responsive to the represented search query and applying the search query to a data source external to the virtual environment, resulting in a plurality of items collectively forming search results; and
an output module displaying the search results as a stream of discrete objects emanating from the search query represented in the virtual environment, each object representing a respective search result item of the plurality of items.

10. An external source data provider as claimed in claim 9 wherein the user interface represents the search query of the certain type in the virtual environment by depicting the search query as any of:
a projection, a visualization and a virtual object.

11. An external source data provider as claimed in claim 9 wherein the output module displaying the search results as a stream of discrete objects includes emanating the stream in an upwards or outwards direction relative to representation of the search query in the virtual environment.

12. An external source data provider as claimed in claim 9 wherein each object representing a respective search result item is an individual data element employing any of a projection, text, graphics and abstract representation of data.

13. An external source data provider as claimed in claim 9 further comprising an interface module enabling a user to take an object from the stream, each object being sufficiently discrete to serve as an individual data element.

14. An external source data provider as claimed in claim 13 wherein the interface module further enables the user to operate on the taken object by any of persisting, manipulating, sharing, annotating and modifying the object.

15. An external source data provider as claimed in claim 9 wherein the output module displaying the search results as a stream of discrete objects further includes making an object disappear from view after a predefined period of time.

16. An external source data provider as claimed in claim 9 wherein the virtual environment is any of:
a virtual object, a 3D video, a simulation, a multi-user online environment and a virtual gaming environment.

17. A computer system comprising:
an interface providing representations of certain search queries in a virtual environment; and
a display module displaying search results of a search query as a separable list of objects emanating from the representation of the search query in the virtual environment, the search results being formed of a plurality of items, and each object being an individual data element corresponding to a respective search result item and being separable from the other objects in the list.

18. A computer system as claimed in claim 17 wherein the certain search queries are queries for data from sources external to the virtual environment.

19. A computer program product for providing external source data, the computer program product comprising:
a computer useable medium having computer useable program code embodied therewith,
the computer useable program code configured to provide, in a separable manner, search results of external data to a virtual environment.

20. The computer program product of claim 19 wherein the computer useable program code is configured to:
provide a search query for external data from sources external to the virtual environment, and
in cooperation with the search query, display search results of the search query as a separable stream of objects emanating from a representation of the search query in the virtual environment, the search results being formed of a plurality of items and each object in the stream being a discrete data element representing a respective search result item.
